(19) United States
(12) Patent Application Publication
(10) Pub. No.: US 2023/0328851 A1
(43) Pub. Date: Oct. 12, 2023

(54) CONTROL KNOB AND COOKING SYSTEM

(71) Applicant: SAMSUNG ELECTRONICS CO., LTD., Suwon-si (KR)

(72) Inventor: Heejun KANG, Suwon-si (KR)

(73) Assignee: SAMSUNG ELECTRONICS CO., LTD., Suwon-si (KR)

(21) Appl. No.: 18/209,042

(22) Filed: Jun. 13, 2023

Related U.S. Application Data
(63) Continuation of application No. PCT/KR2021/017951, filed on Dec. 1, 2021.

(30) Foreign Application Priority Data
Jan. 6, 2021 (KR) 10-2021-0001351

(51) Int. Cl. H05B 6/06; H05B 6/12; H02J 50/10; F21V 23/04

(52) U.S. Cl. CPC H05B 6/062; H05B 6/1218; H02J 50/10; F21V 23/0442

(57) ABSTRACT

A cooking system disclosed herein may comprises a cooking device; and a control knob attachable to the cooking device and including a plurality of light emitting elements, wherein the cooking device is configured to, with the control knob attached to the cooking device, transmit wireless power to the control knob, drive at least one heating coil based on movement of the control knob, determine a target coil to be controlled among the at least one heating coil based on a change in magnetic field detected by a sensor according to movement of the control knob, and control firepower of the target coil, and the control knob is configured to, with the control knob attached to the cooking device, control the plurality of light emitting elements based on magnetic field data received from the cooking device.

### CROSS-REFERENCE TO RELATED APPLICATION

The present application is a continuation application of International Application PCT/KR2021/017951, filed Dec. 1, 2021, and claims foreign priority to Korean Application 10-2021-0001351, filed Jan. 6, 2021, the disclosures of which are incorporated herein by reference.

### BACKGROUND

### 1 Field

The disclosure relates to a control knob used to control a cooking device and a cooking system including the control knob and the cooking device.

### 2. Description of Related Art

Cooking devices are devices for cooking an object to be cooked by heating the object. For example, the cooking devices may include a gas oven that heats the object by burning a gas, an electric oven that heats the object by converting electric energy to thermal energy, a microwave that heats the object by irradiating microwaves to the object, a gas stove that heats a container containing the object by burning a gas, or an induction heating device that heats the container containing the object by generating a magnetic field.

Of the various cooking devices, the induction heating device has advantages that is easy to control, safe, and harmful gas is not emitted because the induction heating device uses electricity as an energy source. Furthermore, the induction heating device may support various functions for cooking food and have high energy efficiency.

In a case of a gas-based cooking device, the user usually uses a dial type of knob provided for each stove to make a fire in the stove and adjust the fire intensity. Furthermore, in a case of the traditional induction heating device, the user uses an analog button or a touch button arranged on a plate to drive a heating coil.

Such input devices equipped in the traditional cooking devices hardly satisfy the needs of the user for a design of the cooking device and have limitation not providing a variety of manipulation methods.

### SUMMARY

According to an embodiment, a control knob may include a housing; a magnet on a bottom surface of the housing and configured to be attachable to a cooking device; a receive coil inside the housing and configured to, with the magnet attached to the cooking device, receive wireless power from the cooking device; a plurality of light emitting elements in the housing; a communication module configured to, with the magnet attached to the cooking device, communicate with the cooking device; and a controller configured to, with the magnet attached to the cooking device, receive magnetic field data varying by movement of the control knob from the cooking device through the communication module, and control the plurality of light emitting elements based on the received magnetic field data.

The controller may be configured to control the plurality of light emitting devices based on a preset light emitting pattern associated with the magnetic field data.

The controller may be configured to determine a light emission zone based on movement of the housing in a Z-axis direction or linear motion of the housing on an XY-plane, and control at least one of the plurality of light emitting elements which is located in the light emission zone to emit light.

The controller may be configured to keep a position of the light emission zone constant while the housing is rotated, and control the plurality of light emitting elements moved into the light emission zone by rotation of the housing to emit light sequentially.

The controller may be configured to keep a position of the light emission zone constant while the housing is rotated, and control the plurality of light emitting elements moved into the light emission zone to change color of light emitted from the light emission zone based on a direction and angle of the rotation of the housing.

The controller may be configured to control the plurality of light emitting elements to change color of the light emitted from the light emission zone at every preset rotation angle based on the rotation of the housing which continues in a same direction.

The controller may be configured to control all the plurality of light emitting elements to emit light for a preset period of time in response to reception of the wireless power.

The housing may include a light transmission window formed of a transparent material or a translucent material.

The controller may be configured to, with the magnet attached to the cooking device, determine reception or blocking of the wireless power based on whether the magnet is attached to a magnetic substance located in a knob area of the cooking device.

The control knob may further include a button assembly which attaches the magnet to the cooking device or separates the magnet from the cooking device based on pressure applied from outside.

The controller may be configured to determine reception or blocking of the wireless power based on switching between attachment and separation of the magnet to and from the cooking device.

The control knob may include a magnetic sensor configured to detect a change in magnetic field caused by movement of the magnet, and the controller may be configured to control the plurality of light emitting elements based on at least one of a change in magnetic field detected by the magnetic sensor or the magnetic field data received from the cooking device.

In an embodiment, a cooking system includes a cooking device, and a control knob attachable to the cooking device and including a plurality of light emitting elements. The cooking device may be configured to, with the control knob attached to the cooking device, transmit wireless power to the control knob, drive at least one heating coil based on movement of the control knob, determine a target coil to be controlled among the at least one heating coil based on a change in magnetic field detected by a sensor according to movement of the control knob, and control firepower of the target coil. The control knob may be configured to, with the control knob attached to the cooking device, control the plurality of light emitting elements based on magnetic field data received from the cooking device.

The cooking device may determine the target coil based on movement of the control knob in a Z-axis direction or linear motion of the control knob on an XY-plane, and the control knob may determine a light emission zone indicating a position of the target coil, and control at least one of the plurality of light emitting elements which is located in the light emission zone to emit light.

The cooking device may adjust firepower of the target coil based on rotation of the control knob, and the control knob may keep a position of the light emission zone constant while rotating, and control the plurality of light emitting elements moved into the light emission zone by the rotation to emit light sequentially.

The cooking device may be configured to, with the control knob attached to the cooking device, control firepower of the target coil based on rotation of the control knob, and the control knob may be configured to, with the control knob attached to the cooking device, keep a position of the light emission zone constant while rotated, and control the plurality of light emitting elements moved into the light emission zone by the rotation to emit light sequentially.

The cooking device may increase or decrease firepower of the target coil based on the rotation of the control knob which continues in a same direction, and the control knob may control the plurality of light emitting elements to change color of the light emitted from the light emission zone at every preset rotation angle while continuously rotating in a same direction.

The cooking device may transmit wireless power to the control knob based on attachment of a first magnet of the control knob to a second magnet located in a knob area of the cooking device.

The second magnet may be provided in the form of a rotational sphere.

The cooking device may include a support shaft arranged in the knob area to support movement of the second magnet, and the second magnet may be provided in the form of a disc having a center supported by the supporting shaft.

According to the disclosure, a control knob and cooking system may make a state of a cooking device controlled by the control knob visible through light emitting elements arranged in the control knob. Accordingly, the user may check the operation state of the cooking device more intuitively through the control knob.

Furthermore, the control knob and cooking system as disclosed herein may have light emitting elements arranged in a control knob, thereby enhancing design elements.

Additional aspects will be set forth in part in the description which follows and, in part, will be apparent from the description, or may be learned by practice of the presented embodiments.

### BRIEF DESCRIPTION OF THE DRAWINGS

Above and other aspects, features, and advantages of certain embodiments of the disclosure will be more apparent from the following description taken in conjunction with the accompanying drawings, in which:

FIG. 1 illustrates a cooking system including a control knob and a cooking device, according to an embodiment.

FIG. 2 illustrates a control panel of a cooking device in detail, according to an embodiment.

FIG. 3 is a control block diagram of a cooking device, according to an embodiment.

FIG. 4 is a cross-sectional view of a control knob and a cooking device, according to an embodiment.

FIG. 5 is a plan view of a control knob viewed from below, according to an embodiment.

FIG. 6 is a control block diagram of a control knob, according to an embodiment.

FIG. 7 illustrates an example of a light emission zone determined by movement of a control knob, according to an embodiment.

FIG. 8 illustrates another example of a light emission zone determined by movement of a control knob, according to an embodiment.

FIGS. 9 and 10 illustrate an example of a plurality of light emitting elements controlled by rotation of a control knob, according to an embodiment.

FIGS. 11 and 12 illustrate an example of a button assembly arranged in a control knob and operation thereof, according to an embodiment.

FIGS. 13 and 14 illustrate another example of a button assembly arranged in a control knob and operation thereof, according to an embodiment.

FIG. 15 is a flowchart describing an operation of a control knob, according to an embodiment.

FIG. 16 is a flowchart describing an operation of a cooking system, according to an embodiment.

FIG. 17 illustrates an example of a magnet arranged in a cooking device, according to an embodiment.

FIG. 18 illustrates another example of a magnet arranged in a cooking device, according to an embodiment.

### DETAILED DESCRIPTION

Like numerals refer to like elements throughout the specification. Not all elements of embodiments of the disclosure will be described, and description of what are commonly known in the art or what overlap each other in the embodiments will be omitted. The term ‘unit, module, member, or block’ may refer to what is implemented in software or hardware, and a plurality of units, modules, members, or blocks may be integrated in one component or the unit, module, member, or block may include a plurality of components, depending on the embodiment of the disclosure.

It will be further understood that the term “connect” or its derivatives refer both to direct and indirect connection, and the indirect connection includes a connection over a wireless communication network or an electric connection through electric wires.

The terminology used herein is for the purpose of describing embodiments and does not limit the disclosure. It is to be understood that the singular forms “a,” “‘an,” and “the” include plural references unless the context clearly dictates otherwise. In the specification, the term “include”, “comprise”, “have”, etc., is used to describe existence of a feature, a number, a step, an operation, a component, a part, or any combination thereof as disclosed herein, but does not rule out including other feature(s) or component(s).

Furthermore, throughout the specification, ordinal numbers used before components are used to distinguish the components from one another, and do not imply order of arrangement, manufacturing, or importance. Descriptions shall be understood as to include any and all combinations of one or more of the associated listed items when the items are described by using the conjunctive term “— and/or —,” or the like. Embodiments of the disclosure will now be described in detail.

Various embodiments of the disclosure provide a control knob attachable to a cooking device to control the cooking device and make the control operation of the cooking device visible, and a cooking system including the knob.

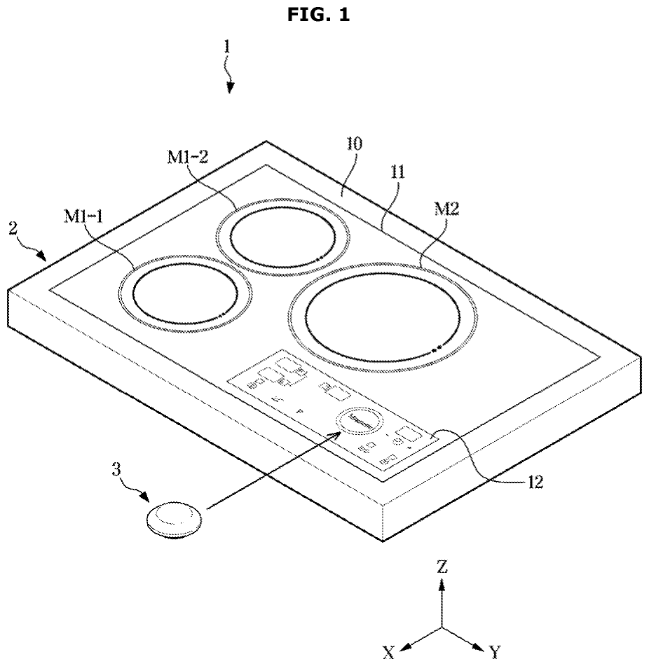

FIG. 1 illustrates a cooking system including a control knob and a cooking device, according to an embodiment.

Referring to FIG. 1, a cooking system 1 may include a cooking device 2 and a control knob 3. The cooking device 2 may be an induction heating device. The cooking device 2 may include a main body 10 that forms an exterior and has various components installed therein. A plate 11 on which a cooking container may be placed may be arranged on a top surface of the main body 10. The plate 11 may include operation zones M1-1, M1-2 and M2 indicating locations in which the cooking container may be heated. The plate 11 may be provided in various materials. For example, the plate 11 may be provided in tempered glass such as ceramic glass.

The operation zones M1-1, M1-2 and M2 may be arranged in positions corresponding to heating coils 210 provided in the main body 10 of the cooking apparatus 2. The operation zones may be provided in the plural. For example, as shown in FIG. 1, there may be 3 operation zones M1-1, M1-2 and M2. The heating coil 210 may be arranged in a location corresponding to each of the plurality of operation zones M1-1, M1-2 and M2. The operation zones M1-1, M1-2 and M2 may be referred to as a first operation zone M1-1, a second operation zone M1-2 and a third operation zone M2. Furthermore, the heating coils 210 corresponding to the first operation zone M1-1, the second operation zone M1-2 and the third operation zone M3 may be called a first heating coil, a second heating coil and a third heating coil.

A control panel 12 may be arranged on the plate 11 to receive a user input and display operation information of the cooking device 2. Although the control panel 12 is illustrated in FIG. 1 as being arranged on the top surface of the plate 11, the control panel 12 may be arranged in other various locations on the cooking device 2. For example, the control panel 12 may be arranged on the front, rear, left or right surface of the cooking device 2.

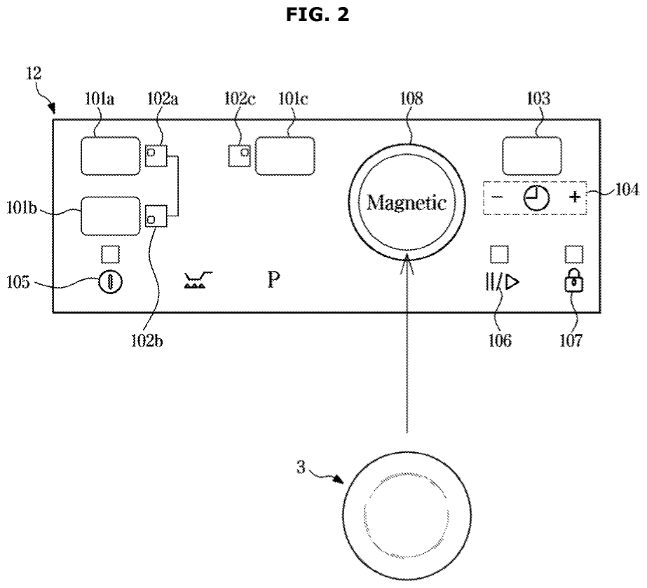

The control panel 12 may include a display and an input module. For example, the control panel 12 may include a touch button, a touch panel and/or a touch screen. Furthermore, the control panel 12 may include a knob area 108 in which the control knob 3 may be attached. A detailed configuration of the control panel 12 is described in FIG. 2.

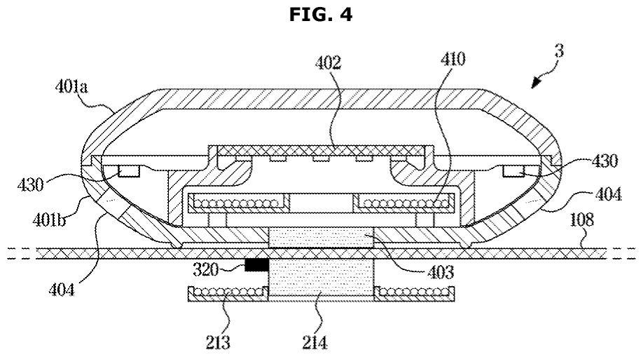

The control knob 3 is attached to the cooking device 2 and may play a role as an input device used to control operations of the cooking device 2. The control knob 3 may be attached in the knob area 108 of the control panel 12. The cooking device 2 may drive at least one heating coil 210 based on movement of the control knob 3. The user may select a target coil to be controlled among the at least one heating coil 210 by manipulating the control knob 3 attached in the knob area 108, and control firepower of the target coil by rotating the control knob 3. Furthermore, the control knob 3 may include a plurality of light emitting elements 430, and visually indicate a state of the cooking device 2 being controlled, through the plurality of light emitting elements 430. With the light emitting elements 430 included in the control knob 3, space for installing the light emitting elements in the plate 11 of the cooking device 2 may be omitted, thereby enhancing design elements of the cooking device 2. A detailed configuration of the control knob 3 is described in FIG. 4.

FIG. 2 illustrates a control panel of a cooking device in detail.

Referring to FIG. 2, the control panel 12 of the cooking device 2 may include a temperature indicator 101, a coil selector 102, a time indicator 103, a time controller 104, a power button 105, a start/stop button 106, a lock button 107 and the knob area 108. The control panel 12 may include a touch button, a touch panel and/or a touch screen, and include a liquid crystal display (LCD) or a light emitting diode (LED).

The temperature indicator 101 may indicate firepower of the active heating coil 210. There may be a number of temperature indicators 101 corresponding to the number of heating coils 210. A first temperature indicator 101a may indicate firepower of the first heating coil arranged underneath the first operation zone M1-1, a second temperature indicator 101b may indicate firepower of the second heating coil arranged underneath the second operation zone M1-2, and a third temperature indicator 101c may indicate firepower of the third heating coil arranged underneath the third operation zone M2. The firepower may be indicated in numbers that represent a heating stage or temperature.

The coil selector 102 may receive an input to select whether to operate each of the at least one heating coil 210. The first coil selector 102a, the second coil selector 103b and the third coil selector 103c corresponds to the first heating coil, the second heating coil and the third heating coil, respectively. The coil selector 102 may be provided as a touch button. The user may select the heating coil 210 intended for activation by touching the coil selector 102.

The time indicator 103 may indicate an operation time of the heating coil 210 selected to be controlled. The time indicator 103 may indicate the time on an hour, minute, and/or second basis. The time indicator 103 may indicate an operation time of the heating coil 210 set by the user, and indicate a number that decreases as the heating coil 210 operates.

The time controller 104 may receive an input to set an operation time of the heating coil 210. For example, the time controller 104 may receive an input to increase the operation time or an input to decrease the operation time.

The power button 105 may receive an input to power on or off the cooking device 2. When a touch input is input to the power button 105 while the cooking device 2 is powered off, the cooking device 2 may be powered on. On the other hand, when a touch input is input to the power button 105 while the cooking device 2 is powered on, the cooking device 2 may be powered off.

The start/stop button 106 may receive an input to start operation of the heating coil 210 selected to be controlled or an input to pause the active heating coil 210.

The lock button 107 may receive an input to set a lock function of the cooking device 2 or an input to release the lock function. The lock function is a function to prevent the cooking device 2 from operating regardless of the user's intent. When the lock function is set, an input to activate the heating coil 210 of the cooking device 2 is disabled.

The knob area 108 is defined as a location where the control knob 3 is attached. A magnet 403 may be arranged on the bottom surface of a housing 401 of the control knob 3, and a magnet 214 may also be arranged underneath the knob area 108. The magnet 403 of the control knob 3 may be referred to as a first magnet, and the magnet 214 of the knob area 108 may be referred to as a second magnet. When the control knob 3 is located in the knob area 108, the control knob 3 may be attached in the knob area 108 by attraction between the first magnet 403 and the second magnet 214.

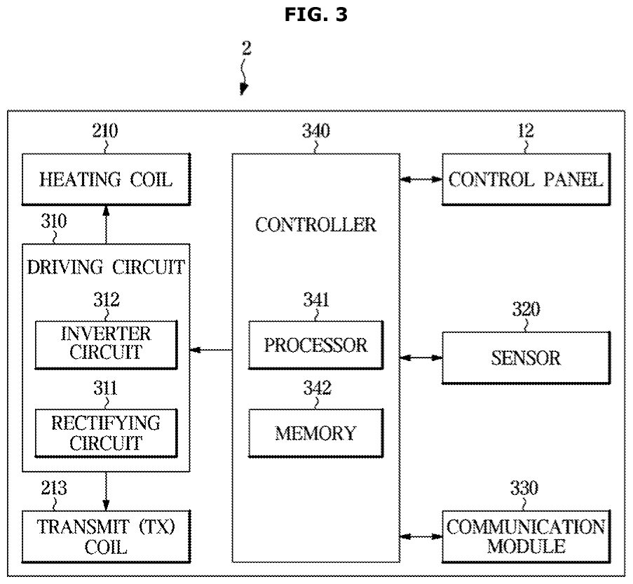

FIG. 3 is a control block diagram of a cooking device.

Referring to FIG. 3, the cooking device 2 according to an embodiment may include the heating coil 210, a transmit coil 213, the control panel 12, a driving circuit 310, a sensor 320, a communication module 330 and a controller 340. The controller 340 may be electrically connected to the components of the cooking device 2, and control operations of each of the components. The controller 340 may include a control circuit. A printed circuit board (PCB) may be arranged in the main body 10, and the driving circuit 310, the sensor 320, the communication module 330 and the controller 340 may be mounted on one or multiple PCBs.

The heating coil 210 may be arranged underneath the plate 11 of the cooking device 2. A number of heating coils 210 corresponding to the number of operation zones M1-1, M1-2 and M2 are provided and arranged in positions corresponding to the respective operation zones M1-1, M1-2 and M2. The heating coil 210 may produce a magnetic field and/or an electromagnetic field based on a current applied from the driving circuit 310. Due to the magnetic field produced by the heating coil 210, the cooking container placed in the operation zone M1-1, M1-2 or M3 of the plate 11 may be heated.

The transmit coil 213 may be arranged underneath the knob area 108 of the control panel 12. The transmit coil 213 may transmit wireless power to the control knob 3. When the control knob 3 is attached in the knob area 108, a receive coil 410 of the control knob 3 is placed on top of the transmit coil 213. The control knob 3 may be operated by using the power transmitted from the transmit coil 213 in the knob area 108 to the receive coil 410.

The driving circuit 310 may apply a current to the heating coil 210 and the transmit coil 213. The driving circuit 310 may receive and rectify power from an external power source, and provide the rectified power to the heating coil 210, the transmit coil 213 and the controller 340. The controller 340 may distribute the power forwarded from the driving circuit 310 to the control panel 12, the sensor 320 and the communication module 330. Alternatively, the driving circuit 310 may directly supply the rectified power to each of the heating coil 210, the transmit coil 213, the controller 340, the control panel 12, the sensor 320 and the communication module 330.

The driving circuit 310 may include a rectifying circuit 311 and an inverter circuit 312. The rectifying circuit 311 may convert alternate current (AC) power to direct current (DC) power. The rectifying circuit 311 may convert an AC voltage with magnitude and polarity (positive voltage or negative voltage) changing in time to a DC voltage with constant magnitude and polarity, and convert an AC current with magnitude and direction (positive current or negative current) changing in time to a DC current with constant magnitude.

The rectifying circuit 311 may include a bridge diode. For example, the rectifying circuit 311 may include four diodes. The diodes may form two pairs of diodes, each pair having two diodes connected in series, and the two pairs of diodes may be connected in parallel with each other. The bridge diode may convert an AC voltage with polarity changing in time to a positive voltage with constant polarity, and convert an AC current with directions changing in time to a positive current having a constant direction.

Furthermore, the rectifying circuit 311 may include a DC link capacitor. The DC link capacitor may convert a positive voltage with magnitude changing in time to a DC voltage with constant magnitude. The DC link capacitor may maintain and provide the converted DC voltage to the inverter circuit 312.

The inverter circuit 312 may switch the voltage applied to each of the heating coil 210 and the transmit coil 213 so that a current flows through the heating coil 210 and the transmit coil 213. The inverter circuit 312 may include a switching circuit for applying or blocking the current to the heating coil 210 and the transmit coil 213 and a resonant capacitor. The switching circuit may include at least one switching device. One end of each of the heating coil 210 and the transmit coil 213 may be connected to a connection point of the switching device, and the other end of each of the heating coil 210 and the transmit coil 213 may be connected to the resonant capacitor. The switching device may be turned on or off according to a control signal of the controller 340. With the switching operation (on/off) of the switching device, a current and voltage may be applied to the heating coil 210 and the transmit coil 213.

The resonant capacitor may serve as a buffer. The resonant capacitor controls a rate of increase in saturation voltage while the switching device is turned off, affecting the energy loss. Furthermore, the resonant capacitor determines a resonant frequency of the heating coil 210 and the transmit coil 213. The switching device is turned on or off at high speed, and thus may be implemented with 3-terminal semiconductor switching device having high response speed. For example, the switching device may be a bipolar junction transistor (BJT), a metal-oxide semiconductor field effect transistor (MOSFET), an insulated gate bipolar transistor (IGBT), or a thyristor.

Each of the heating coil 210 and the transmit coil 213 forms a magnetic field with the current applied from the inverter circuit 312. Due to the magnetic field produced by the heating coil 210, the cooking container placed in the operation zone M1-1, M1-2 or M3 of the plate 11 may be heated. Furthermore, due to the magnetic field produced by the transmit coil 213, a current and voltage may be applied to the receive coil 410 of the control knob 3.

The sensor 320 may detect a magnetic field and/or magnetic force that varies by movement of the control knob 3. The sensor 320 may detect a change in magnetic field with respect to three axes, X-axis, Y-axis, and Z-axis. The sensor 320 may be located near the magnet 214 underneath the knob area 108. The sensor 320 may be implemented as a magnetic sensor. For example, the sensor 320 may be a hall sensor.

The sensor 320 may detect a change in magnetic field produced when the control knob 3 is attached in the knob area 108 of the control panel 12. In other words, the sensor 320 may detect a magnetic field that varies when the first magnet 403 of the control knob 3 approaches the second magnet 214 in the knob area 108.

Furthermore, the sensor 320 may detect the change in magnetic field that is made when the control knob 3 is moved in the knob area 108. For example, a change in magnetic field may be made between the first magnet 403 of the control knob 3 and the second magnet 214 in the knob area 108 according to movement of the control knob 3 in a direction of the Z-axis. When the user pushes an edge of the control knob 3, movement of the control knob 3 may occur, and accordingly, there may be a change in magnetic field formed by the magnet 403 or 214. The sensor 320 may detect a subtle change in magnetic field in the direction of the Z-axis.

There may be a change in magnetic field as the control knob 3 makes linear motion on the XY-plane. In other words, the control knob 3 may be moved in the top left direction of the control panel 12 in the knob area 108 and then returned to the center of the knob area 108 according to manipulation by the user. When the user moves the control knob 3 completely out of the knob area 108 of the control panel 12, the control knob 3 may not return to the center of the knob area 108. But when the movement of the control knob 3 is made within a range affected by the attraction between the first magnet 403 of the control knob 3 and the second magnet 214 of the cooking device 2, the control knob 3 may return to the center of the knob area 108 due to the attraction of the magnets 403 and 213. Such movements of the control knob 3 may cause changes in magnetic field.

Furthermore, the magnetic field may be changed even when the control knob 3 is rotated in the knob area 108. The control knob 3 may be rotated based on the second magnet 214 in the knob area 108 as an axis. When the control knob 3 is rotated, the N-pole and the S-pole of the first magnet 403 are rotated. The sensor 320 may detect a change in polarity of the first magnet 403 due to the rotation of the control knob 3.

The sensor 320 may send the changing magnetic field data to the controller 340. The controller 340 may obtain coordinate data regarding the movement of the control knob 3 based on the magnetic field data obtained by the sensor 320. The controller 340 may represent the movement of the control knob 3 in a two dimensional (2D) coordinate system or a three dimensional (3D) coordinate system. The cooking device 2 may transmit the coordinate data regarding the movement of the control knob 3 to the control knob 3.

Furthermore, the controller 340 may determine the movement of the control knob 3 based on inductance of the transmit coil 213 that varies by the control knob 3. The inductance of the transmit coil 213 measured when the control knob 3 is in the knob area 108 is different from the inductance of the transmit coil 213 measured when the control knob 3 is not in the knob area 108. Based on such a difference in inductance, the movement of the control knob 3 may be determined. The movement of the control knob 3 may be detected in other various methods.

Moreover, the cooking device 2 may include various sensors. For example, the cooking device 2 may further include a temperature sensor and a weight sensor.

The communication module 330 may communicate with the control knob 3. The communication module 330 may be implemented by various radio communication technologies. For example, the communication module 330 may employ at least one of radio frequency (RF), infrared communication, wireless fidelity (Wi-Fi), Bluetooth, Zigbee or near field communication (NFC). Preferably, the communication module 330 may be an NFC module. The communication module 330 of the cooking apparatus 2 may be referred to as a first communication module.

The controller 340 may include a processor 341 and a memory 342. The memory 342 may store a program, instructions, and data for controlling the operation of the cooking device 2. The processor 341 may generate control signals for controlling the operation of the cooking device 2 based on the program, instructions and data memorized and/or stored in the memory 342. The controller 340 may be implemented with a control circuit having the processor 341 and the memory 342 mounted thereon. Furthermore, the controller 340 may include a plurality of processors and a plurality of memories. The controller 340 of the cooking device 2 may be referred to as a first controller.

The processor 341 may include logic circuits and operation circuits in hardware. The processor 341 may process the data according to the program and/or instructions provided from the memory 342 and generate a control signal based on the processing result. The memory 342 may include a volatile memory such as a static random access memory (SRAM), dynamic RAM (DRAM), etc., for temporarily storing data, and a non-volatile memory such as a read only memory (ROM), an erasable programmable ROM (EPROM), an electrically erasable programmable (ROM) (EEPROM), etc., for storing data for a long time.

Apart from this, the cooking device 2 may further include other components.

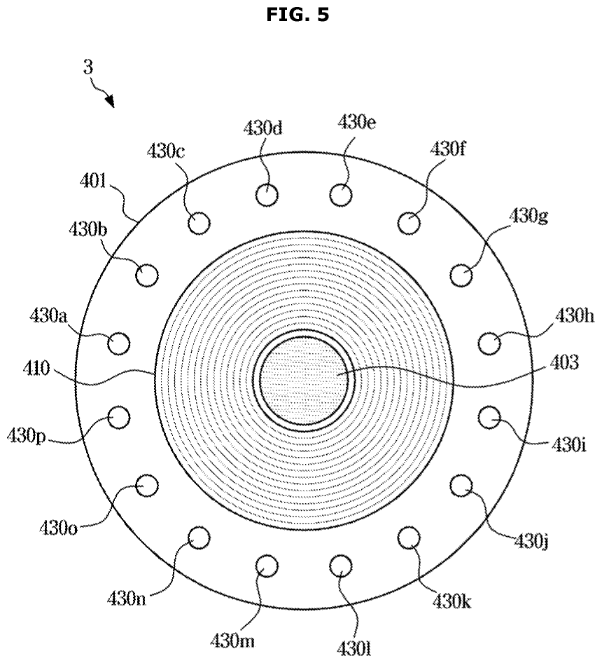

FIG. 4 is a cross-sectional view of a control knob and a cooking device, according to an embodiment. FIG. 5 is a plan view of a control knob viewed from below, according to an embodiment.

Referring to FIG. 4, the control knob 3 may include the housing 401, a circuit board 402 arranged in the housing 401, the first magnet 403 arranged on the bottom surface of the housing 401, the receive coil 410 that receives wireless power from the transmit coil 213 of the cooking device 2, and the plurality of light emitting elements 430.

In FIG. 4, the cooking device 2 is briefly shown as including some components. The cooking device 2 may include the knob area 108 of the control panel 12, the transmit coil 213 arranged underneath the knob area 108, the second magnet 214 located in the center of the transmit coil 213 underneath the knob area 108, and the sensor 320 for obtaining magnetic field data changing by movement of the control knob 3. The sensor 320 may be located near the second magnet 214.

Each of the first magnet 403 of the control knob 3 and the second magnet 214 of the cooking device 2 may include the N-pole and the S-pole. The second magnet 214 of the cooking device 2 may be a ferromagnetic body in which magnetic moments are aligned. For example, the second magnet 214 may be a permanent magnet.

The housing 401 of the control knob 3 may include an upper housing 401a and a lower housing 401b. The upper housing 401a and the lower housing 401b may be combined to form the whole housing 401. Alternatively, the upper housing 401a and the lower housing 401b may not be separated but integrally formed as the one housing 401. The plane of the housing 401 viewed from above may have the form of a circle, and a cross-section of the housing 401 viewed from a side may have the form of an ellipse. The bottom surface of the housing 401 may be flat, and may include a hole to expose part of the first magnet 403. The aforementioned shape of the housing 401 is merely an example, and the housing 401 may have various shapes.

The lower housing 401b may be formed of a transparent or translucent material. Accordingly, the light from the plurality of light emitting elements 430 may be emitted to the outside through the lower housing 401b. Alternatively, the light transmission window 404 may be arranged on the lower housing 401b. The light transmission window 404 may be arranged along the circumference of the lower housing 401b. The light transmission window 404 may be formed of a transparent or translucent material. The light from the plurality of light emitting elements 430 may be emitted to the outside through the light transmission window 404. In the case that the lower housing 401b includes the light transmission window 404, the other portion of the lower housing 401b may be formed of an opaque material.

The first magnet 403 of the control knob 3 may be moved along with the housing 401. For example, when the housing 401 is rotated, the first magnet 403 may be rotated as well. As the housing 401 and the first magnet 403 are rotated together, a change in magnetic field may be made between the first magnet 403 and the second magnet 214 of the cooking device 2.

The circuit board 402 may be arranged in the housing 401, and may include an electric circuit for operating the control knob 3. A power conversion circuit 420, a communication module 440 and a controller 470 may be arranged on the circuit board 402. The circuit board 402 may be electrically connected to the plurality of light emitting elements 430 to operate the plurality of light emitting elements 430.

The receive coil 410 may receive power from the transmit coil 213 of the cooking device 2. When the control knob 3 is arranged in the knob area 108 of the cooking device 2, the receive coil 410 receives wireless power through electromagnetic induction. The magnet 403 of the control knob 3 may be located in the center of the receive coil 410. Furthermore, the receive coil 410 may be located above the magnet 403. Alternatively, when the size of the magnet 403 is smaller than the size of the hole formed in the center of the receive coil 410, the magnet 403 may be arranged to pass through the center of the receive coil 410.

Referring to FIG. 5, the plurality of light emitting elements 430 may be arranged at regular intervals to form a circle. The plurality of light emitting elements 430 may be arranged between the inner surface of the housing 401 and the receive coil 410. The first to sixteenth light emitting elements 430a to 430p may be arranged to be spaced apart to form a circle. Although 16 light emitting elements 430 are illustrated in FIG. 5, the number of the light emitting elements 430 may be variously arranged and the layout of the light emitting elements 430 may be changed depending on the design.

When the control knob 3 is powered on, all the plurality of light emitting elements 430 may be controlled to emit light for a preset period of time. Afterward, according to movement of the control knob 3 attached in the knob area 108 of the control panel 12, the plurality of light emitting elements 430 may be controlled individually.

The respective light emitting elements 430 may emit light of different colors. The controller 470 of the control knob 3 may determine color of the light to be emitted from each of the light emitting elements 430.

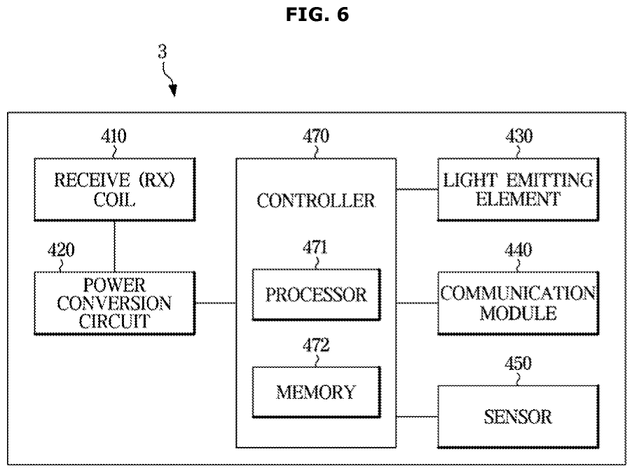

FIG. 6 is a control block diagram of a control knob, according to an embodiment.

Referring to FIG. 6, the control knob 3 may include the receive coil 410, the power conversion circuit 420, the light emitting elements 430, the communication module 440 and the controller 470. Furthermore, the control knob 3 may further include a sensor 450. Although not shown, a touch button and/or a touch screen may be arranged on the top surface of the housing 401.

The receive coil 410 and the power conversion circuit 420 may supply power to each of the light emitting elements 430, the communication module 440, the sensor 450 and the controller 470. Alternatively, the controller 470 may distribute the power received from the power conversion circuit 420 to the light emitting elements 430, the communication module 440 and the sensor 450.

The power conversion circuit 420 may include a rectifying circuit. An AC voltage and AC current may be applied to the receive coil 410 that receives the power from the transmit coil 213 of the cooking device 2. As the light emitting elements 430, the communication module 440, the sensor 450 and the controller 470 of the control knob 3 require DC power, the power conversion circuit 420 is needed. The power conversion circuit 420 may include a DC-DC converter for applying suitable power to each component of the control knob 3.

The communication module 440 may communicate with the cooking device 2. The communication module 440 may be implemented by various radio communication technologies. For example, the communication module 440 may employ at least one of RF, infrared communication, Wi-Fi, Bluetooth, Zigbee or NFC. The communication module 440 may be preferably an NFC module. The communication module 440 of the control knob 3 may be referred to as a second communication module.

The sensor 450 may detect a magnetic field and/or magnetic force that varies by movement of the control knob 3. The sensor 450 may detect the change in magnetic field with respect to three axes, the X-axis, the Y-axis, and the Z-axis. The sensor 450 may be located near the first magnet 403. The sensor 450 may be implemented as a magnetic sensor. For example, the sensor 450 may be a hall sensor. The sensor 450 of the control knob 3 may play the same role as the sensor 320 of the cooking device 2. The sensor 320 of the cooking device 2 may be called a first sensor and the sensor 450 of the control knob 3 may be called a second sensor.

The controller 470 of the control knob 30 may control the the plurality of light emitting elements 430 based on magnetic field data transmitted from the sensor 320 of the cooking device 2. When the control knob 3 includes the sensor 450, the controller 470 of the control knob 30 may control the plurality of light emitting elements 430 based on at least one of the magnetic field data transmitted from the cooking device 2 and a change in magnetic field detected by the sensor 450. When both the magnetic field data obtained by the cooking device 2 and the change in magnetic field obtained by the sensor 450 of the control knob 3 are used, the movement of the control knob 3 may be determined more accurately. Only the sensor 450 of the control knob 30 may obtain the magnetic field data without the sensor 320 of the cooking device 2.

The controller 470 may include the processor 471 and the memory 472. The controller 470 may be electrically connected to the components of the control knob 3 to control the components. Specifically, the controller 470 may control the power conversion circuit 420, the light emitting elements 430, the communication module 440 and the sensor 450. The controller 470 of the control knob 3 may be referred to as a second controller.

A preset light emission pattern associated with magnetic field data may be stored in the memory 472. The controller 470 may control the plurality of light emitting elements 430 by using the magnetic field data changing by the movement of the control knob 3 and the preset light emission pattern.

The controller 470 may determine reception or blocking of the wireless power based on whether the first magnet 403 and the second magnet 214 located in the knob area 108 of the cooking device 2 are attached to each other. In other words, when the first magnet 403 of the control knob 3 is attached to the second magnet 214 of the cooking device 2, the controller 470 may control the power conversion circuit 420 to distribute the received wireless power. On the other hand, when the first magnet 403 of the control knob 3 is separated from the second magnet of the cooking device 2, the controller 470 may determine to block the wireless power.

When the wireless power is received through the receive coil 410, the controller 470 may control all the plurality of light emitting elements 430 to emit light for a preset period of time. Light emission from all the plurality of light emitting elements 430 may be to notify that the control knob 3 is powered on. Afterward, the controller 470 may individually control the plurality of light emitting elements 430 according to movement of the control knob 3 attached in the knob area 108 of the control panel 12.

Operations of the control knob and cooking system will now be described in detail according to an embodiment.

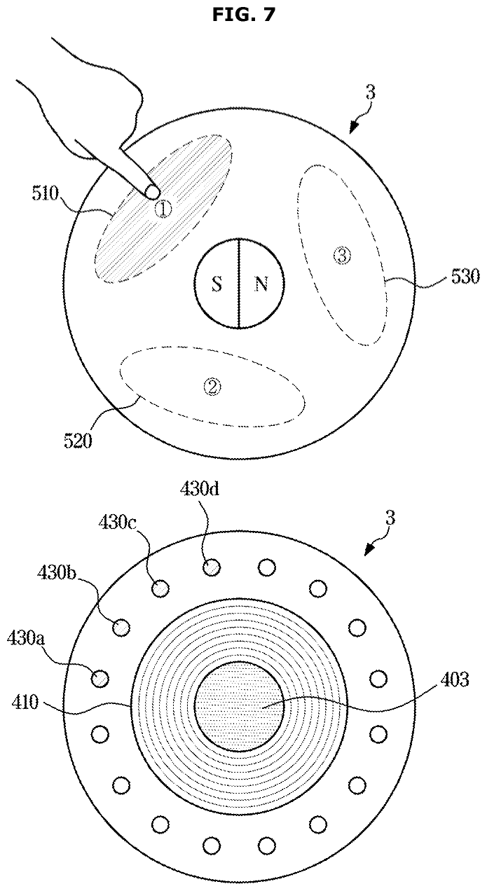

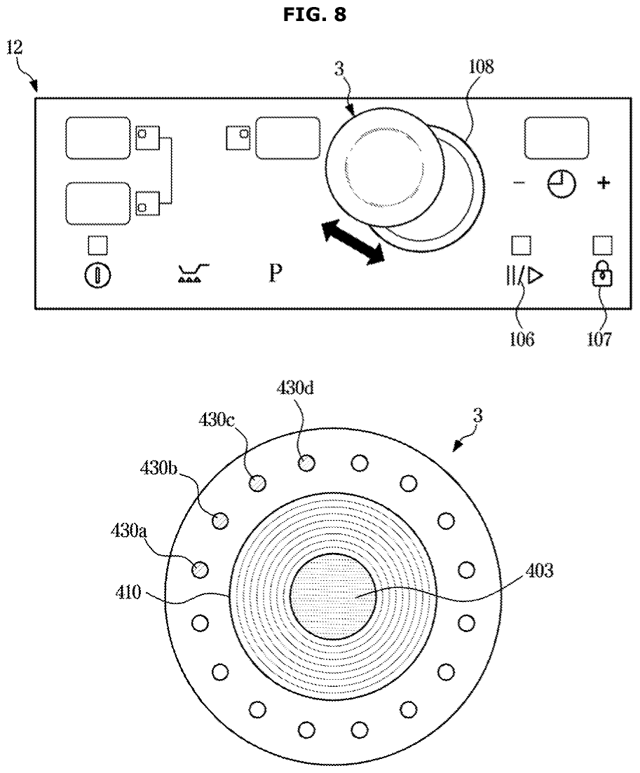

FIG. 7 illustrates an example of a light emission zone determined by movement of a control knob, according to an embodiment. FIG. 8 illustrates another example of a light emission zone determined by movement of a control knob, according to an embodiment.

In FIGS. 7 and 8, the control knob 3 is placed in the knob area 108 of the control panel 12. The controller 470 of the control knob 3 may determine a light emission zone based on movement of the housing 401 in the direction of the Z-axis or linear motion of the housing 401 on the XY-plane. Furthermore, the controller 470 of the control knob 3 may control at least one light emitting element 430 located in the light emission zone to emit light.

The light emission zone of the control knob 3 may be formed in a location corresponding to the location of the heating coil 210 of the cooking device 2. A first light emission zone 510 may indicate the first heating coil corresponding to the first operation zone M1-1 located in the top left portion on the plate 11 of the cooking device 2, a second light emission zone 520 may indicate the second heating coil corresponding to the second operation zone M1-2 located in the bottom left portion on the plate 11, and the third light emission zone 530 may indicate the third heating coil corresponding to the third operation zone M2 located on the right side on the plate 11.

Referring to FIG. 7, when force is applied to a first position of edges of the top surface of the housing 401 in the direction of the Z-axis, the housing 401 may be moved in the direction of the Z-axis and the first magnet 403 may also be moved together. Accordingly, there may be a change in magnetic field of the Z-axis. At least one of the sensor 320 of the cooking device 2 and the sensor 450 of the control knob 3 may detect the change in magnetic field of the Z-axis and obtain magnetic field data. The direction of the Z-axis may refer to a direction perpendicular to the plane of the plate 11 of the cooking device 2.

The controller 470 of the control knob 3 may identify that force is applied to the first position \textcircled{1} based on the magnetic field data obtained. Accordingly, the controller 470 of the control knob 3 may set the first light emission zone 510 corresponding to the first position \textcircled{1} on the housing 401. The controller 470 of the control knob 3 may control the first, second, third and fourth light emitting elements 430a, 430b, 430c and 430d located in the first light emission zone 510 to emit light. The remaining light emitting elements from the fifth to sixteenth light emitting elements 430e to 430p may be controlled not to emit light.

The controller 470 of the control nob 3 may determine the first heating coil located underneath the first operation zone M1-1 as a target to be controlled, based on the change in magnetic field made in the first position \textcircled{1} on the control knob 3. That is, the first heating coil may be determined as a target coil. The light emitted from the first light emission zone 510 may indicate that the first heating coil of the first operation zone M1-1 is selected as a target to be controlled.

When a change in magnetic field of the Z-axis is detected from a second position \textcircled{2} on the control knob 3, the controller 470 of the control knob 3 may set the second light emission zone 520 corresponding to the second position \textcircled{2} on the housing 401, and the cooking device 2 may determine the second heating coil located underneath the second operation zone M1-2 as a target to be controlled. Furthermore, when a change in magnetic field of the Z-axis is detected from a third position \textcircled{3} on the control knob 3, the controller 470 of the control knob 3 may set the third light emission zone 530 corresponding to the third position \textcircled{3} on the housing 401, and the third heating coil located underneath the third operation zone M2 may be determined as a target to be controlled.

Referring to FIG. 8, the controller 470 of the control knob 3 may determine a light emission zone based on linear motion of the housing 401 on the XY-plane. For example, the control knob 3 may be moved in the top left direction of the control panel 12 in the knob area 108 and then returned to the center of the knob area 108 according to manipulation by the user. Sliding of the control knob 3 may be made within a range that is affected by the attraction between the first magnet 403 of the control knob 3 and the second magnet 214 of the cooking device 2. The sliding of the control knob 3 may make a change in magnetic field.

The controller 470 of the control knob 3 may identify that the housing 401 is moved in the top left direction based on the magnetic field data that has changed in the top left direction on the XY-plane. Accordingly, the controller 470 of the control knob 3 may set the first light emission zone 510 located on top left edges of the housing 401. The controller 470 of the control knob 3 may control the first, second, third and fourth light emitting elements 430a, 430b, 430c and 430d located in the first light emission zone 510 to emit light. The remaining light emitting elements from the fifth to sixteenth light emitting elements 430e to 430p may be controlled not to emit light.

The controller 470 of the cooking device 2 may determine the first heating coil located underneath the first operation zone M1-1 as a target to be controlled, based on the change in magnetic field made in the top left direction on the XY-plane. That is, the first heating coil may be determined as a target coil. The light emitted from the first light emission zone 510 may indicate that the first heating coil of the first operation zone M1-1 is selected as a target to be controlled.

Furthermore, when the control knob 3 slides in the bottom left direction in the knob area 108, the controller 470 of the control knob 3 may set the second light emission zone 520 and the cooking device 2 may determine the second heating coil as a target coil. When the control knob 3 slides to the right in the knob area 108, the controller 470 of the control knob 3 may set the third light emission zone 530 and the cooking device 3 may determine the third heating coil as a target coil.

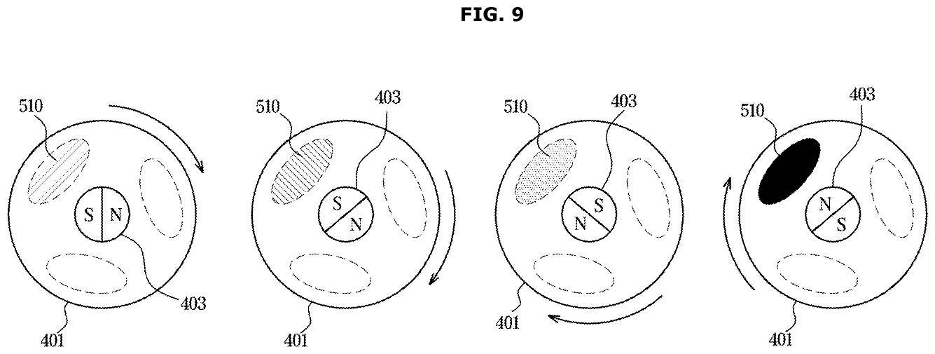

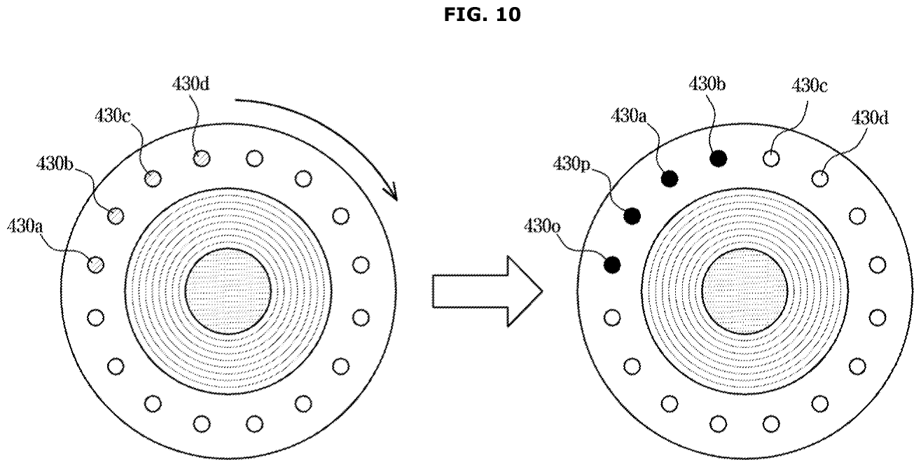

FIGS. 9 and 10 illustrate an example of a plurality of light emitting elements controlled by rotation of a control knob, according to an embodiment.

Referring to FIG. 9, the controller 470 of the control knob 3 may keep the position of the light emission zone 510 constant while the housing 401 and the first magnet 403 are rotated, and control the plurality of light emitting elements 430 moved into the light emission zone 510 by the rotation of the housing 401 to sequentially emit light.

When the housing 401 is rotated after the light emission zone of the control knob 3 is determined to be the first light emission zone 510, the first light emission zone 510 may be kept the same. In other words, the position of the first light emission zone 510 that indicates the first heating coil of the first operation zone M1-1, which is the target coil, may not be changed. The plurality of light emitting elements 430 may sequentially pass through the first light emission zone 510 by rotation of the housing 401.

Referring to FIG. 10, while the first to fourth light emitting elements 430a to 430d located in the first light emission zone 510 emit light, the light emitting elements 430 located in the first light emission zone 510 may be changed by rotation of the housing 401. By the rotation of the housing 401, the fifteenth and sixteenth light emitting elements 430o and 430p that are moved into the first light emission zone 510 are controlled to emit light, and the third and fourth light emitting elements 430c and 430d that are moved out of the first light emission zone 510 are controlled not to emit light. That is, the third and fourth light emitting elements 430c and 430d that are moved out of the first light emission zone 510 are turned off.

Furthermore, the controller 470 of the control knob 3 may sequentially control the plurality of light emitting elements 430 moved into the light emission zone 510 to change color of the light emitted from the light emission zone 510 based on the direction and angle of the rotation of the housing 401. The controller 470 of the control knob 3 may control the plurality of light emitting elements 430 to change color of the light emitted from the light emission zone 510 at every preset rotation angle while the housing 401 and the first magnet 403 are continuously rotated in the same direction.

As shown in FIG. 9, when the housing 401 is continuously rotated to the right, color of the light emitted from the first light emission zone 510 may be changed. For example, based on the housing 401 continuously rotated to the right, the color of the light may be changed in the order of green, yellow, orange and red at every preset rotation angle (e.g., 90 degrees).

The cooking device 2 may control firepower of the target coil based on the rotation of the control knob 3. The cooking device 2 may increase or decrease the firepower of the target coil based on the rotation of the control knob 3 that continues in the same direction. For example, when the control knob 3 is continuously rotated to the right while being attached in the knob area 108 of the control panel 12, the firepower of the first heating coil determined as a target to be controlled may increase. When the control knob 3 is continuously rotated to the left, the firepower of the first heating coil may be reduced. The firepower of the target coil may be changed at every preset rotation angle (e.g., 90 degrees) of the control knob 3.

As such, a control state of the cooking device 2 according to the control knob 3 may be visualized by controlling the light emitting elements 430 of the control knob 3.

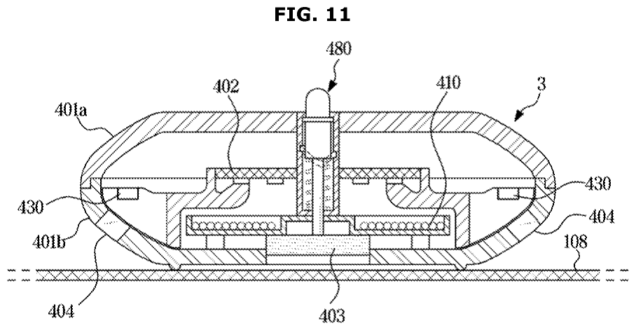

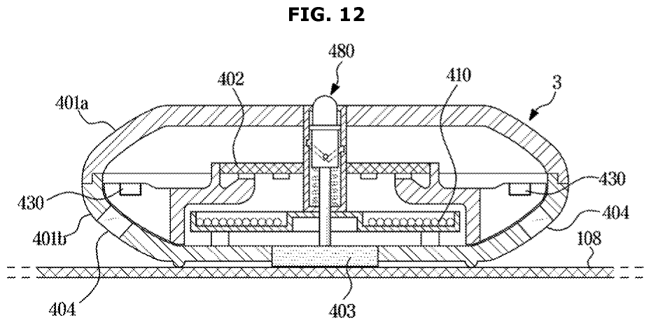

FIGS. 11 and 12 illustrate an example of a button assembly arranged in a control knob and operation thereof.

Referring to FIGS. 11 and 12, the control knob 3 may further include a button assembly 480 that attaches the first magnet 403 to the cooking device 2 or separates the first magnet 403 from the cooking device 2 based on pressure applied from outside. The button assembly 480 may be arranged to pass through the center of the control knob 3. A push pad exposed to the top surface of the control knob 3 may be arranged at one end of the button assembly 480. The other end of the button assembly 480 may be coupled to the first magnet 403. By manipulation of the button assembly 480, the first magnet 403 of the control knob 3 may be attached in the knob area 108 of the control panel 12 or separated from the knob area 108.

The internal structure of the button assembly 480 may be provided in various forms. For example, the button assembly 480 may include a case, a supporter coupled to the first magnet 403 and passing through the case, and a spring arranged in the case to return the push pad to the original position. Grooves may be formed in the inner surface of the case and the surface of the push pad, and a ball may be arranged between the grooves. The position of the push pad may be fixed by the grooves and the ball. Apart from this, various structures of the button assembly may be applied.

The controller 470 of the control knob 3 may determine reception or blocking of the wireless power based on the switching between attachment and separation of the first magnet 403 to and from the cooking device 2. The user may switch between attachment and separation of the first magnet 403 to and from the cooking device 2 by manipulating the button assembly 480. Before the user pushes the button assembly 480, the magnet 403 is located inside the housing 401 and the surface of the magnet 403 makes a step with the bottom surface of the housing 401. The magnet 403 may then be separated from the surface of the knob area 108.

When the user pushes the button assembly 480, the magnet 403 of the control knob 3 may closely contact the surface of the knob area 108 of the plate 11. Accordingly, the first magnet 403 of the control knob 3 and the second magnet 214 underneath the knob area 108 may be coupled together. When the button assembly 480 is pushed again while the magnet 403 of the control knob 3 closely contacts the surface of the knob area 108, the magnet 403 may be separated from the surface of the knob area 108.

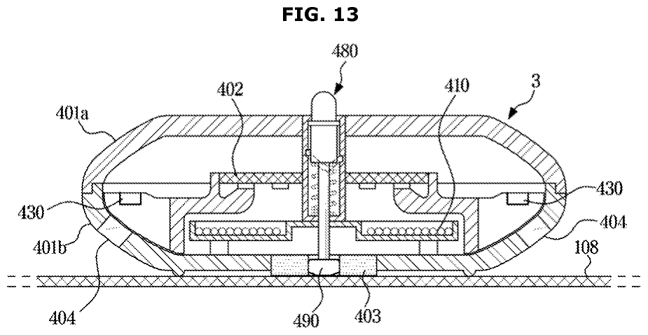

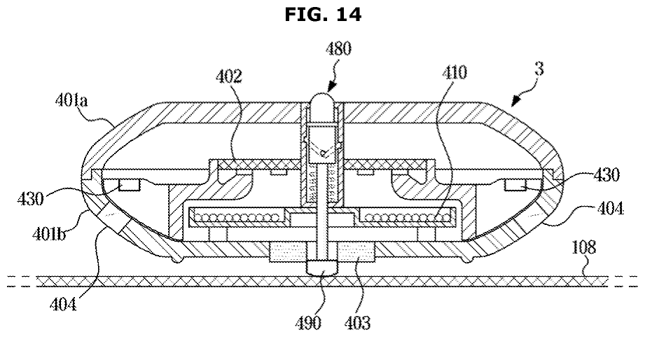

FIGS. 13 and 14 illustrate another example of a button assembly arranged in a control knob and operation thereof.

Referring to FIGS. 13 and 14, the button assembly 480 may be arranged to pass through the center of the control knob 3. A push pad exposed to the upper surface of the control knob 3 may be arranged at one end of the button assembly 480. A separation member 490 that passes through the magnet 403 may be arranged at the other end of the button assembly 480.

Before the user pushes the button assembly 480, the separation member 490 may be positioned inside the housing 401 and the magnet 403 of the control knob 3 may closely contact the surface of the knob area 108. When the user pushes the button assembly 480, the separation member 490 may protrude out of the housing 401. As the separation member 490 protrudes out of the housing 401 from the center of the magnet 403, the magnet 403 may be separated from the surface of the knob area 108 due to the protrusion of the separation member 490.

When the button assembly 480 is included in the control knob 3, the control knob 3 may be powered off even while located in the knob area 108 of the plate 11. As such, there may be various methods of powering on or off the control knob 3 by the button assembly 480.

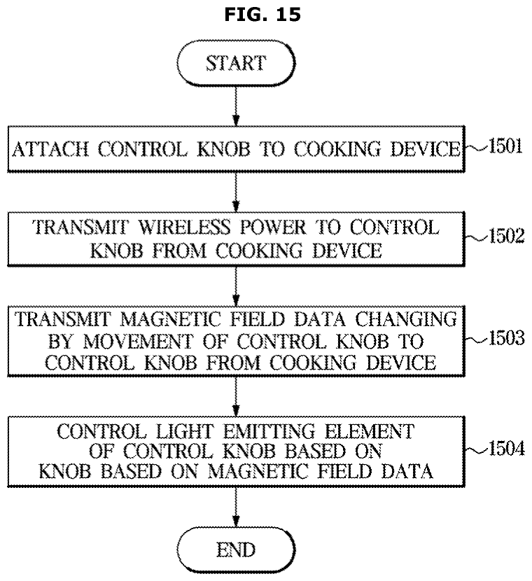

FIG. 15 is a flowchart describing an operation of a control knob, according to an embodiment.

Referring to FIG. 15, the control knob 3 may be attached to the cooking device 2, in 1501. When the control knob 3 is attached to the cooking device 2, the control knob 3 may receive wireless power from the cooking device 2, in 1502. Specifically, when the first magnet 403 of the control knob 3 is attached in the knob area 108 of the control panel 12 arranged on the plate 11 of the cooking device 2, the controller 470 of the control knob 3 may receive the wireless power through the receive coil 410.

The controller 470 of the control knob 3 may then receive magnetic field data that changes by movement of the control knob 3 from the cooking device 2 through the communication module 440, in 1503. As described above, the control knob 3 may be vertically or horizontally moved or rotated while attached in the knob area 108 of the cooking device 2. With the movement of the control knob 3, the magnetic field formed between the magnet 403 of the control knob 3 and the magnet 214 of the cooking device 2 may be changed.

The controller 470 of the control knob 3 may control the plurality of light emitting elements 430 of the control knob 3 based on the magnetic field data. The controller 470 may control the plurality of light emitting elements 430 by using the magnetic field data changing by the movement of the control knob 3 and a preset light emission pattern. The controller 470 of the control knob 3 may determine a light emission zone based on movement of the housing 401 in the direction of the Z-axis or linear motion of the housing 401 on the XY-plane. Furthermore, the controller 470 of the control knob 3 may control at least one light emitting element 430 located in the light emission zone to emit light.

The controller 470 of the control knob 3 may keep the position of the light emission zone 510 constant while the housing 401 and the first magnet 403 are rotated, and control the plurality of light emitting elements 430 moved into the light emission zone 510 by the rotation of the housing 401 to sequentially emit light. The controller 470 of the control knob 3 may sequentially control the plurality of light emitting elements 430 moved into the light emission zone 510 to change color of the light emitted from the light emission zone 510 based on the direction and angle of the rotation of the housing 401.

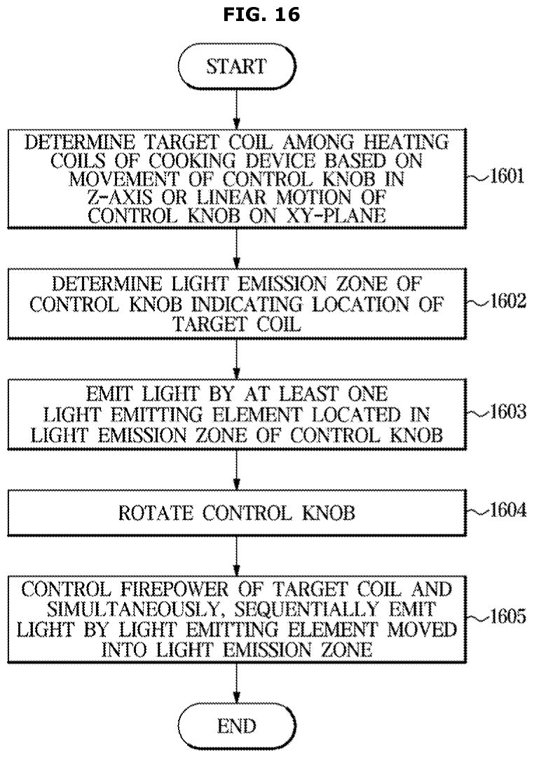

FIG. 16 is a flowchart describing an operation of a cooking system, according to an embodiment.

Referring to FIG. 16, the cooking device 2 may drive at least one heating coil 210 based on movement of the control knob 3. The cooking device 2 may determine a target coil to be controlled among at least one heating coil 210 based on a change in magnetic field detected by the sensor 320 according to the movement of the control knob 3. Specifically, the cooking device 2 may determine a target coil based on movement of the control knob 3 in the direction of the Z-axis or linear motion of the control knob 3 on the XY-plane, in 1601.

The control knob 3 may determine a light emission zone that indicates a location of a target coil based on magnetic field data transmitted from the cooking device 2, in 1602. The control knob 3 may control at least one light emitting element 430 located in the light emission zone to emit light, in 1603.

The control knob 3 may be rotated while attached in the knob area 108 of the cooking device 2, 1604. The cooking device 2 may control firepower of the target coil based on the rotation of the control knob 3. At the same time, the control knob 3 may control the plurality of light emitting elements 430 moved into the light emission zone to sequentially emit light, in 1605. The control knob 3 may sequentially control the plurality of light emitting elements 430 moved into the light emission zone to change color of the light emitted from the light emission zone based on the direction and angle of the rotation.

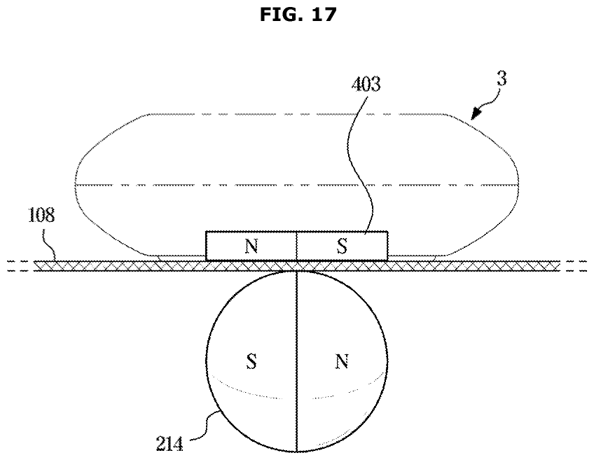

FIG. 17 illustrates an example of a magnet arranged in a cooking device.

Referring to FIG. 17, the control panel 12 of the cooking device 2 may include the knob area 108 in which the control knob 3 may be attached. The second magnet 214 may be arranged underneath of the knob area 108. The second magnet 214 may be provided in the form of a rotational sphere, and coupled with the first magnet 403 and moved together. As the second magnet 214 is provided in the form of a rotational sphere, the change in magnetic field in the direction of the Z-axis may be detected more accurately. Hence, the plurality of light emitting elements 430 may be more accurately controlled to correspond to the movement of the control knob 3.

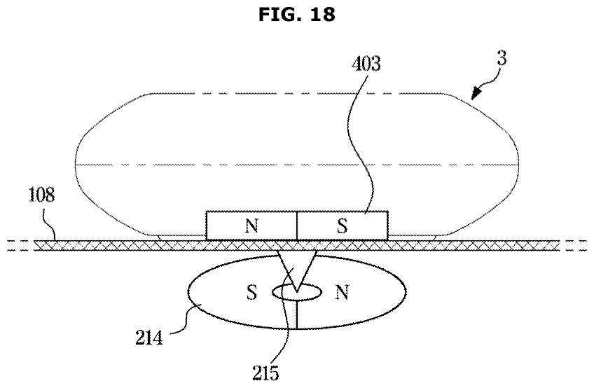

FIG. 18 illustrates another example of a magnet arranged in a cooking device.

Referring to FIG. 18, the cooking device 2 may include a support shaft 215 arranged underneath the knob area 108 to support movement of the second magnet. Although the support shaft 215 is shown in FIG. 18 as having the shape of a cone, it may have various shapes. The second magnet 214 of the cooking device 2 may be provided in the form of a disc with the center supported by the support shaft 215. For example, a hole may be formed in the center of the second magnet 214 having the shape of a disc. The support shaft 215 may pass through the hole of the second magnet 214. Alternatively, a sunken structure may be formed in the center of the second magnet 214 having the shape of a disc. The support shaft 215 may be inserted to the sunken structure of the second magnet 214.

The second magnet 214 having the shape of a disc may be coupled and moved along with the first magnet 403 of the control knob 3. As the second magnet 214 is provided in the form of a movable disc, the change in magnetic field in the direction of the Z-axis may be detected more accurately. Hence, the plurality of light emitting elements 430 may be more accurately controlled to correspond to the movement of the control knob 3.

As described above, a control knob and cooking system as disclosed herein may make a state of a cooking device controlled by the control knob visible through light emitting elements arranged in the control knob. Accordingly, the user may check the operation state of the cooking device more intuitively through the control knob.

Furthermore, the control knob and cooking system as disclosed herein may have the light emitting elements arranged in a control knob, thereby enhancing design elements.

Meanwhile, the embodiments of the disclosure may be implemented in the form of a storage medium for storing instructions to be carried out by a computer. The instructions may be stored in the form of program codes, and when executed by a processor, may generate program modules to perform operation in the embodiments of the disclosure.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

The aforementioned methods according to the various embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

What is claimed is:

1. A cooking system comprising:
a cooking device; and
a control knob attachable to the cooking device and including a plurality of light emitting elements,
wherein the cooking device is configured to, with the control knob attached to the cooking device:
transmit wireless power to the control knob,
drive at least one heating coil based on movement of the control knob,
determine a target coil to be controlled among the at least one heating coil based on a change in magnetic field detected by a sensor according to movement of the control knob, and
control firepower of the target coil, and
wherein the control knob comprises:
a housing;
a magnet on a bottom surface of the housing and configured to be attachable to a cooking device;
a receive coil inside the housing and configured to, with the magnet attached to the cooking device, receive wireless power from the cooking device;
a plurality of light emitting elements in the housing;
a communication module configured to, with the magnet attached to the cooking device, communicate with the cooking device; and
a controller configured to, with the magnet attached to the cooking device, receive magnetic field data varying by movement of the control knob from the cooking device through the communication module, and control the plurality of light emitting elements based on the received magnetic field data.

2. The cooking system of claim 1, wherein the controller is configured to control the plurality of light emitting devices based on a preset light emitting pattern associated with the magnetic field data.

3. The cooking system of claim 1, wherein the controller is configured to determine a light emission zone based on movement of the housing in a Z-axis direction or linear motion of the housing on an XY-plane, and control at least one of the plurality of light emitting elements which is located in the light emission zone to emit light.

4. The cooking system of claim 3, wherein the controller is configured to keep a position of the light emission zone constant while the housing is rotated, and control the plurality of light emitting elements moved into the light emission zone by rotation of the housing to emit light sequentially.

5. The cooking system of claim 3, wherein the controller is configured to keep a position of the light emission zone constant while the housing is rotated, and control the plurality of light emitting elements moved into the light emission zone to change color of light emitted from the light emission zone based on a direction and angle of the rotation of the housing.

6. The cooking system of claim 5, wherein the controller is configured to control the plurality of light emitting elements to change color of the light emitted from the light emission zone at every preset rotation angle based on the rotation of the housing which continues in a same direction.

7. The cooking system of claim 1, wherein the controller is configured to control all the plurality of light emitting elements to emit light for a preset period of time in response to reception of the wireless power.

8. The cooking system of claim 1, wherein the housing includes:
a light transmission window formed of a transparent material or a translucent material.

9. The cooking system of claim 1, wherein the controller is configured to, with the magnet attached to the cooking device, determine reception or blocking of the wireless power based on whether the magnet is attached to a magnetic substance located in a knob area of the cooking device.

10. The cooking system of claim 1, wherein the control knob further comprising:
a button assembly which attaches the magnet to the cooking device or separates the magnet from the cooking device based on pressure applied from outside.

11. The cooking system of claim 9, wherein the controller is configured to determine reception or blocking of the wireless power based on switching between attachment and separation of the magnet to and from the cooking device.

12. The cooking system of claim 1, wherein the control knob further comprising:
a magnetic sensor configured to detect a change in magnetic field caused by movement of the magnet,
wherein the controller is configured to control the plurality of light emitting elements based on at least one of a change in magnetic field detected by the magnetic sensor or the magnetic field data received from the cooking device.

13. The cooking system of claim 1, wherein
the cooking device is configured to determine the target coil based on movement of the control knob in a Z-axis direction or linear motion of the control knob on an XY-plane.

14. The cooking system of claim 13, wherein
the cooking device is configured to, with the control knob attached to the cooking device, control firepower of the target coil based on rotation of the control knob.

15. The cooking system of claim 14, wherein the cooking device configured to increase or decrease firepower of the target coil based on the rotation of the control knob which continues in a same direction.

16. The cooking system of claim 1, wherein the cooking device configured to transmit wireless power to the control knob based on attachment of a first magnet of the control knob to a second magnet located in a knob area of the cooking device.

17. The cooking system of claim 16, wherein the second magnet is provided in the form of a rotational sphere.

18. The cooking system of claim 16, wherein the cooking device further comprises a support shaft arranged in the knob area to support movement of the second magnet.

19. The cooking system of claim 18, wherein the second magnet is provided in the form of a disc having a center supported by the supporting shaft.
